(19) United States
(12) Patent Application Publication
(10) Pub. No.: US 2008/0155025 A1
(43) Pub. Date: Jun. 26, 2008

(54) System and Method for Registering a Template with an Email Address that Accepts Well-Formatted Contents

(76) Inventors: Li Xu, Cary, NC (US); Jianjun Zhang, Cary, NC (US)

Correspondence Address: IBM CORPORATION - RSW (JVL);C/O VAN LEEUWEN & VAN LEEUWEN, P.O. BOX 90609, AUSTIN, TX, 78709-0609, US

(21) Appl. No.: 11/614,171

(22) Filed: Dec. 21, 2006

(51) Int. Cl. G06F 15/16

(52) U.S. Cl. 709/206

(57) ABSTRACT

A system, method, and computer program product register templates with corresponding account names. A content template is registered, or associated, with a corresponding account name, such as an email address. The template includes a predesigned format, or structure, including fields to be filled in by a user. There may be multiple templates that correspond to a given account name or email address. A “retrieve template” function is made available as an option by a user computer email program. A user requests or selects the “retrieve template” function in order to obtain the template that corresponds to a particular account name. A template is returned to the user computer email program, where it is incorporated into the body of the user's email message. The user then fills in the fields of the template and sends the email request. Using a template makes it more likely that all correct information will be sent from the user to the corresponding email address, thus resulting in a faster and more accurate response to the user.

### BACKGROUND OF THE INVENTION

1. Technical Field

The present invention relates to a system and method for registering a template with an email address. More particularly, the present invention relates to a system and method for associating a template with an email address so that a user computer email program can retrieve and use the associated template as part of an email request.

2. Description of the Related Art

Often times, a corporation or other organization sets up an email address to solicit information or to act as a gateway for requesting services. The email address may be monitored by an email server or service provider. When an email message is sent to the email address, the email server or service provider reads the contents of the email message, and uses the information from the email message to provide a specific service or reply.

In order to provide the requested service or reply, the email message must contain specific information. For example, an email address may be set up to provide employees in a corporation with a verification of employment letter. The employee sends an email request to a particular email address in the human resources area. The email request must include specific information in order for the human resources server to respond and correctly mail a verification of employment letter to the employee. For example, the email request may need to include the employee's serial number, full name, and home address. However, the employee may not know what information needs to be provided in order to request a verification of employment letter. In the example given, this means that the employee will most likely need to find and access his company's human resources web site, navigate the web site to the section or page regarding verification of employment letters, read the information regarding the necessary information to be provided, and then type the necessary information into an email message that is sent to the appropriate human resources email account. At any point in the process, the employee may become frustrated or may be unable to find the necessary information.

What is needed therefore, is a system and method for efficiently determining the information needed to request a service from an email address that is monitored by an email server or service provider. What is further needed is a system and method for efficiently and accurately requesting the service by sending the needed information.

### SUMMARY

It has been discovered that the aforementioned challenges are resolved using a method that sends a template request from a user computer email program to an email server, where the template request includes an email account name. The email server selects a template, from a template storage, that corresponds to the email account name, and sends the selected template to the user computer email program. The user computer email program then displays the selected template within an email message, such that the template becomes part of the body of the email message.

In another embodiment, the method further provides determining, by the email server, that more than one stored template corresponds to the email account name. The email server then sends a list of function names to the user computer email program, where each function name is associated with one of the stored templates that corresponds to the email account name. The user computer email program receives and displays the list of function names, and then receives a selection of a function name from a user. In response to receiving the selected function name from the user, the user computer email program than sends a specific template request to the email server, the specific template request including the email account name and the selected function name.

In another embodiment, the aforementioned challenges are resolved using an information handling system capable of executing the methods described above. In yet another embodiment, the aforementioned challenges are resolved using a computer program product stored in a computer operable media, and containing instructions which, when executed by computer, cause the computer to execute the methods described above.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

The present invention may be better understood, and its numerous objects, features, and advantages made apparent to those skilled in the art by referencing the accompanying drawings, wherein:

FIG. 1 is a system diagram showing a client computer, email server(s), and service providers connected via a network;

FIG. 2 is a flowchart showing the steps taken to manage templates;

FIG. 3 is a flowchart showing the steps taken to receive and store a new or modified template;

FIG. 4 is a diagram of a user computer email program that retrieves a template in accordance with the present invention;

FIG. 5 is a diagram of a user computer email program that retrieves a template when more than one template corresponds to a given account name;

FIG. 6 is a flowchart showing the steps taken to request and retrieve a template in accordance with the present invention;

FIG. 7 is a flowchart showing the steps taken to complete a template and process the completed template in accordance with the present invention; and

FIG. 8 is a block diagram of a data processing system in which the methods described herein can be implemented.

### DETAILED DESCRIPTION

The following is intended to provide a detailed description of an example of the invention and should not be taken to be limiting of the invention itself. Rather, any number of variations may fall within the scope of the invention, which is defined in the claims following the description.

The present invention is a method, information handling system, and computer program product that register templates with corresponding account names. A content template is registered, or associated, with a corresponding account name, such as an email address. The template includes a predesigned format, or structure, including fields to be filled in by a user. As discussed in further detail below, there may be multiple templates that correspond to a given account name or email address.

The present invention further includes a method, system, and computer program product for retrieving templates for use by a user of a computer system. A “retrieve template” function is made available as an option by a user computer email program. A user requests or selects the “retrieve template” function in order to obtain the template that corresponds to a particular account name. For example, a user may wish to request a product brochure from an email address, such as brochures@ibm.com. The user types the email address, brochures@ibm.com into the “To” line of the user computer email program, and then selects the “retrieve template” option. A template is returned to the user computer email program, where it is incorporated into the body of the user's email message. The user then fills in the fields of the template and sends the brochure request. Using a template makes it more likely that all correct information will be sent from the user to the corresponding email address, thus resulting in a faster and more accurate response to the user.

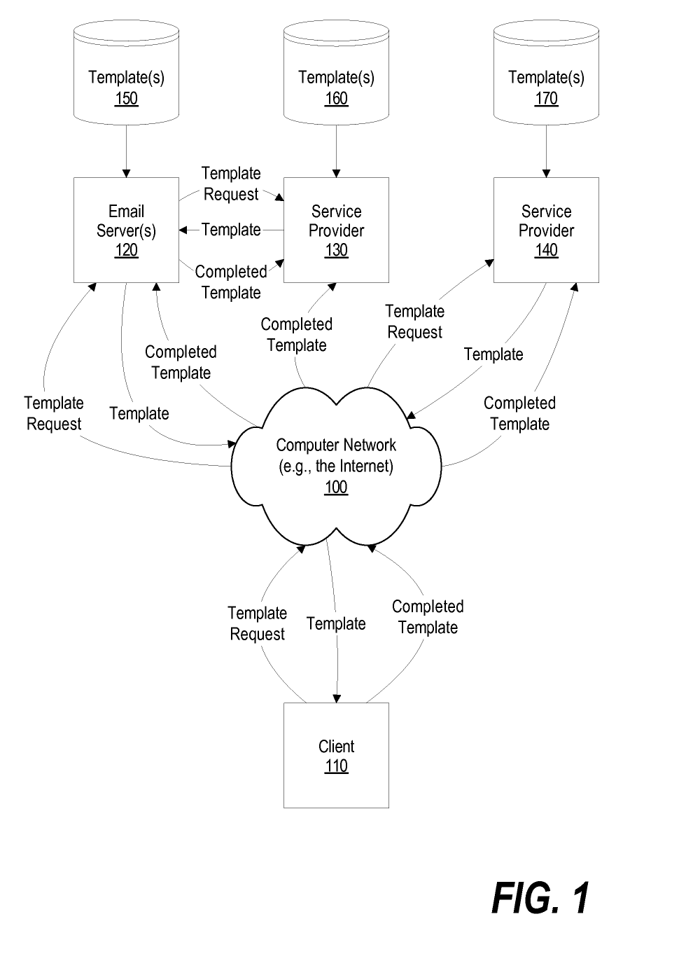

FIG. 1 is a is a system diagram showing client 110, email server 120, and service providers 130 and 140 connected via computer network 100. Note that any number of clients, email servers, and service providers may be included in the system. Network 100 may be any type of network, including, but not limited to the Internet, an intranet, a wireless or radio network, a virtual private network (VPN), etc. A user, using a user computer email program (not shown) on client 110, sends a retrieve template request to an email server, such as email server 120, or to a service provider, such as service provider 140. The retrieve template request may be sent in a variety of ways. For example, email server 120 or service provider 140 may expose a Web Service for requesting templates. In this case, client 110 formats the template request according to the exposed Web Services API and sends it to email server 120 or service provider 140 using the designated Web Services technology. In an alternative embodiment, the retrieve template request may be sent as an email request.

In one example shown in FIG. 1, client 110 sends a retrieve template request to email server 120, via network 100. Email server 120 receives the retrieve template request and retrieves the appropriate template from template storage 150. The template is then sent, via network 100, to client 110. Note, for example, that the template may be sent to client 110 as the response from the Web Service for requesting templates, or as a return email. The user fills in the template with the necessary information, and sends the completed template, via network 100, to email server 120. In another example, email server 120 receives the retrieve template request from client 110 and forwards the template request to service provider 130. Service provider 130 retrieves the appropriate template from template storage 160 and sends the template to email server 120. Email server 120 then sends the template to client 110. The user fills in the template with the necessary information and then sends the completed template to email server 120, where it is then passed along to service provider 130. Alternately, the user may send the completed template directly to service provider 130.

In another example shown in FIG. 1, client 110 sends a retrieve template request to service provider 140. Service provider 140 retrieves the appropriate template from template storage 170, and sends the retrieved template to client 110. The user fills in the template with the necessary information, and send the completed template, via network 100, to service provider 140.

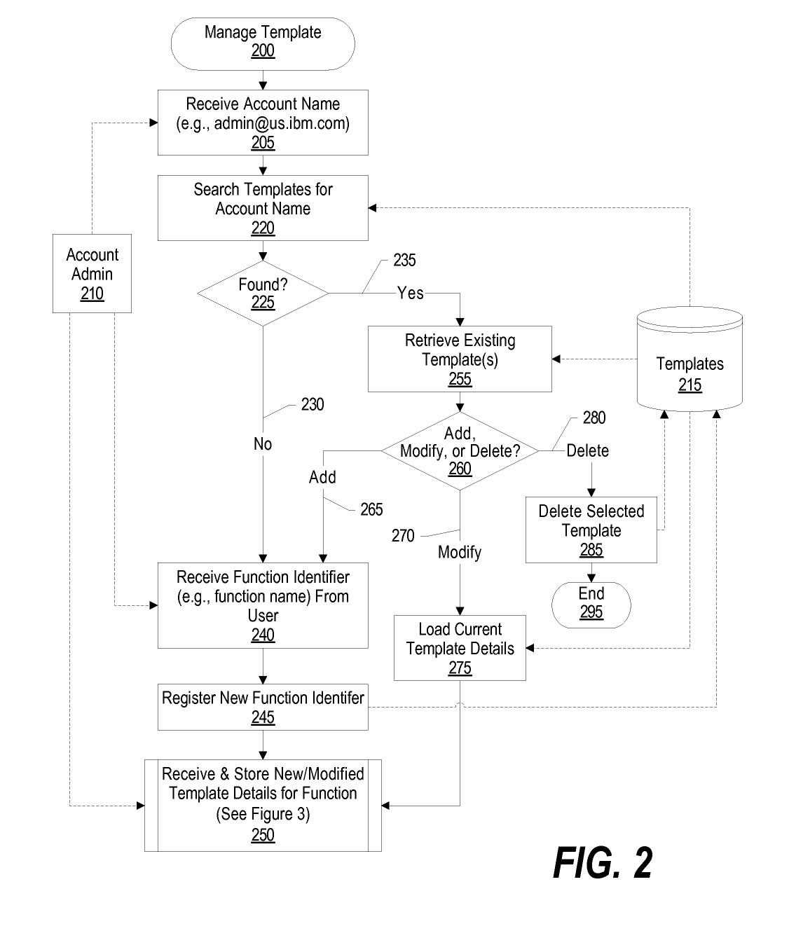

FIG. 2 is a flowchart showing the steps taken to manage templates. Processing begins at 200 whereupon an account name is received (step 205) from account admin 210. In the described embodiment, an account administrator, such as account admin 210, manages the templates for one or more account names, or email addresses. An account name may have one template associated with it, or an account name may have multiple templates associated with it. For example, an email account, such as verify@ibm.com, may be set up to respond to employee requests for verification of employment letters. This email address may have one template associated with it, with input fields that include an employee serial number, full name, and mailing address. As another example, an email account, such as customer.service@ibm.com may be set up to respond to two types of customer service requests. A template for technical support may include fields for a customer number, contact information, problem description, and severity. A template for a brochure request may include fields for a product number and a mailing address.

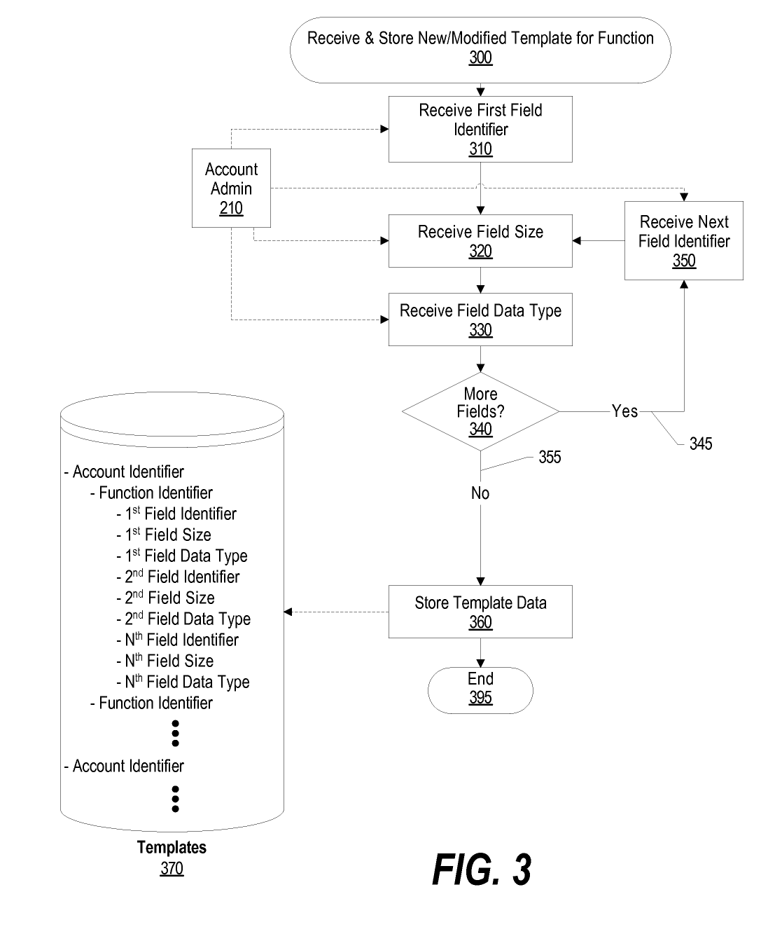

The account name received in step 205 is typically an email address, such as admin@us.ibm.com. The templates in template storage 215 are searched to see if a template, or templates, already exist that correspond to the account name (step 220). A determination is made as to whether or not the account name is found in template storage 215 (decision 225). If the account name is not found, decision 225 branches to “no” branch 230, whereupon a function identifier, or function name, is received from account admin 210 (step 240). If the account name is only going to have one template associated with it, the function identifier may be the same as the account name. On the other hand, if the account name is going to have more than one template associated with it, each template associated with the account name may have its own function identifier or function name. The new function identifier is registered, along with the account name, in template storage 215 (step 245). The template details for the function are then received from account admin 210 (pre-defined process 250) as depicted in FIG. 3. Note that when the user selects retrieve template button 415, a template request is created. The template request includes the email address, i.e. account name, that the user typed into “To” box 420. Those skilled in the art will understand that the retrieve template request may take the form of a web services request or an email request.

Returning to decision 225, if the account name is found in template storage 215, then decision 225 branches to “yes” branch 235, whereupon the existing template that corresponds to the account name is retrieved (step 255). If there is more than one template that corresponds to the account name, it may be necessary to prompt account admin 210 to determine which template, or function, is requested. A determination is made as to whether account admin 210 wishes to add a template, i.e. function, to an existing account name, modify an existing template, or delete an existing template (decision 260). If account admin 210 wishes to add a function to an existing account name, decision 260 branches to “add” branch 265, whereupon processing continues with step 240 as described above. On the other hand, if account admin 210 wishes to modify the current template, decision 260 branches to “modify” branch 270, whereupon the current template details are loaded (step 275), and then processing continues with pre-defined process 250 as depicted in FIG. 3. If account admin 210 wishes to delete the current template, then decision 260 branches to “delete” branch 280, whereupon the selected template is deleted from template storage 215 (step 286). Processing then ends at 295.

FIG. 3 is a flowchart showing the steps taken to receive and store a new or modified template. Processing begins at 300 whereupon a first field identifier is received from account admin 210 (step 310). A field size is received (step 320) and a field data type is also received (step 330). For example, in the example discussed above with regard to verification of employment letters, the first field may an employee serial number. The field identifier may be SERNUM, the field size may be six, and the field type may be “character.” The field size and field type may be used to perform error checking when a user fills in the template. Note that other information may be associated with a field. For example, a field may have a given number of set choices that a user selects via a dropdown menu or a radio button. For example, in the example discussed with regard to requesting technical support, the field for problem severity may have three selections, “critical severity,” “high severity,” and “low severity.” The template, when viewed by the user, may allow the user to select a checkbox or radio button in order to note the severity of the problem.

A determination is made as to whether there are additional fields in the template (decision 340). If there are additional fields, decision 340 branches to “yes” branch 345, whereupon the next field identifier is received (step 350). Processing then continues at step 320. If, on the other hand, there are no more fields, decision 340 branches to “no” branch 355, whereupon the template is stored in template storage 370 (step 360). Processing then ends at 395.

Note that template storage 370 may be organized in any manner of ways. For example, the template information may be stored in a hierarchical manner as depicted in the example shown in FIG. 3. Each account name may include one or more function names, each function name corresponding to a different template. Each template may have one or more fields, and each field within a template may have an identifier, size, data type, and other types of information associated with it. As discussed above, an account name may have only one corresponding template. In this situation, the function identifier may or may not be used. In this case, it is also possible for the function identifier to be the same as the account name.

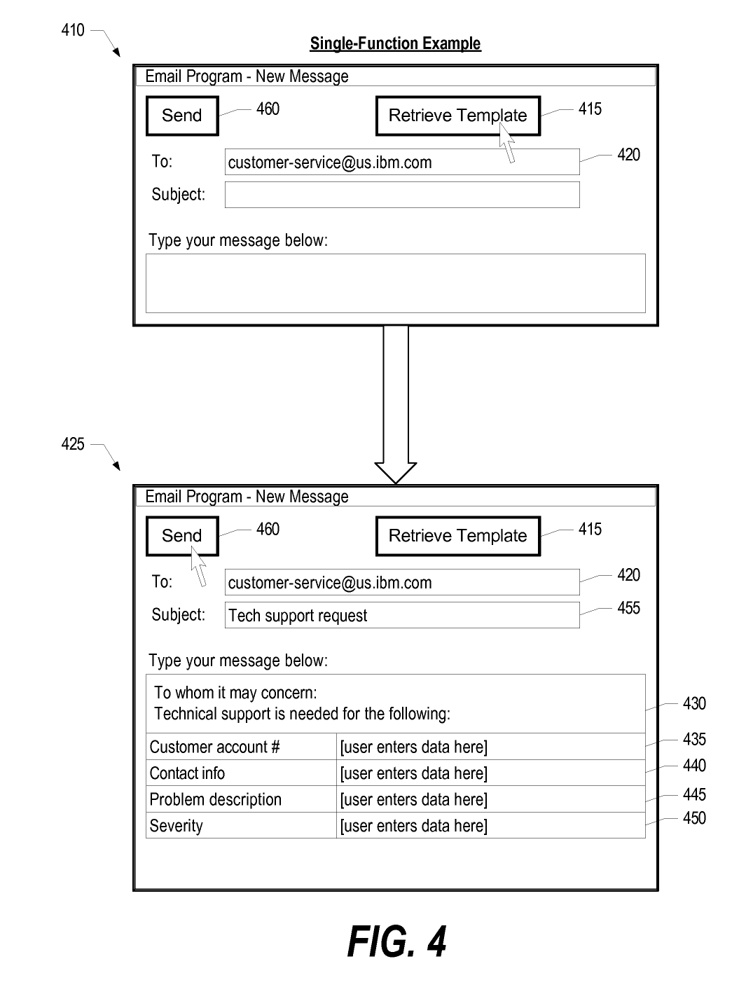

FIG. 4 is a diagram of a user computer email program that retrieves a template in accordance with the present invention. In the example shown in FIG. 4, window 410 is an exemplary send mail window associated with a user computer email program. Window 410 includes retrieve template button 415. Those skilled in the art will understand that the retrieve template option may be implemented in a variety of ways, including, but not limited to a button, a menu selection, a pull-down menu, etc. A user of the user computer email program types an email address in “To” box 420. In the example shown, the user has typed in the email address customer-service@us.ibm.com. The user then selects retrieve template button 415, resulting in window 425, as shown in FIG. 4. Note that when the user selects retrieve template button 415, a template request is created. The template request includes the email address, i.e. account name, that the user typed into “To” box 420. Note that the retrieve template request may be implemented in a variety of ways, for example, by an email server or service provider exposing a Web Service for requesting templates. In an alternative embodiment, the retrieve template request may be an email request.

The retrieve template option retrievedstemplate 430, which is incorporated into the body of the outgoing email message. Template 430 includes customer account number field 435, contact info field 440, problem description field 445, and severity field 450. Each of these fields is then filled in by the user of the user computer email program. As discussed above, with reference to FIG. 3, each of the fields in template 430 may have a field identifier, field size, and field data type associated with it. Further, the user may be prompted to enter specific data, selected from menu of possible choices, for each field in template 430. In the example shown in FIG. 4, there is only one template associated with the account name customer-service@us.ibm.com. Also, in this example, subject line 455 is filled in for the user, indicating that the particular account name, i.e. customer-service@us.ibm.com, is used to request technical support. After filling in fields 435, 440, 445, and 450, the user selects send button 460 to send the completed template to the email address customer-service@us.ibm.com.

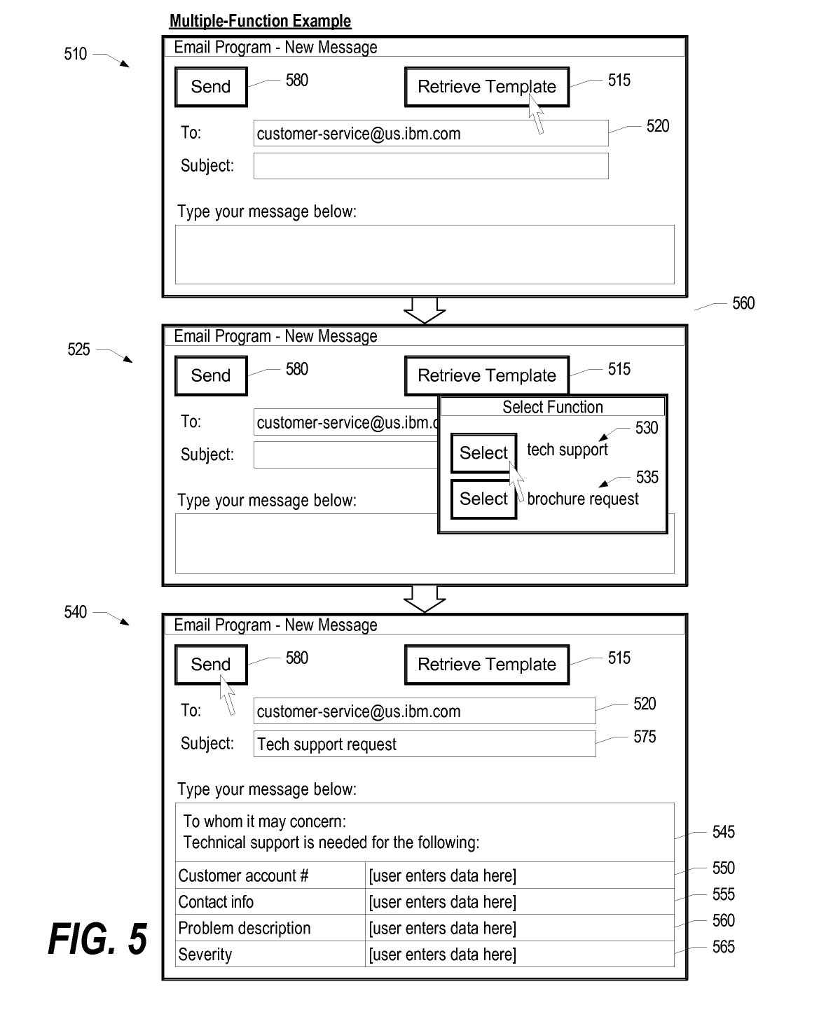

FIG. 5 is a diagram of a user computer email program that retrieves a template when more than one template corresponds to a given account name. In the example shown in FIG. 5, window 510 is an exemplary send mail window associated with a user computer email program. Window 510 includes retrieve template button 515. A user of the user computer email program types an email address in “To” box 520. In the example shown, the user has typed in the email address customer-service@us.ibm.com. The user then selects retrieve template button 515, resulting in window 525, as shown in FIG. 5. Note that when the user selects retrieve template button 515, a template request is created. The template request includes the email address, i.e. account name, that the user typed into “To” box 520. Note that the retrieve template request may be implemented in a variety of ways, for example, by an email server or service provider exposing a Web Service for requesting templates. In an alternative embodiment, the retrieve template request may be an email request.

Because there is more than one template associated with the account name customer-service@us.ibm.com, the user is given an option to select either tech support button 530 or brochure request button 535. In the example shown in FIG. 5, the user selects tech support button 530, resulting in the retrieve template option retrieving template 545, as shown in window 540. Note that when the user selects tech support button 530, a specific template request is created. The specific template request includes the email address, i.e. account name, that the user typed into “To” box 520, along with the function name or function identifier corresponding to “tech support.” Note that the specific template request may be implemented in a variety of ways, for example, by an email server or service provider exposing a Web Service for requesting templates, or the specific template request may be an email request. In an alternative embodiment, both templates, i.e. the template for a brochure request and the template for tech support, may be sent to the user computer email program. When the user makes a selection for a specific template, the user computer email program then selects the appropriate template and incorporates it into the body of the email.

In the example shown, template 545 is incorporated into the body of the email message, and includes customer account number field 550, contact info field 555, problem description field 560, and severity field 565. Each of these fields is then filled in by the user of the user computer email program. As discussed above, with reference to FIG. 3, each of the fields in template 545 may have a field identifier, field size, and field data type associated with it. Further, the user may be prompted to enter specific data, selected from menu of possible choices, for each field in template 545. In the example shown in FIG. 5, subject line 575 is filled in for the user, indicating that the selected template is used to request technical support. After filling in fields 550, 555, 560, and 565, the user selects send button 580 to send the completed template to the email address customer-service@us.ibm.com. When the completed template is received by the email server, it will be handled as a request for customer service. Subject line 575 may be used as a function identifier to indicate which of the templates associated with account name customer-service@us.ibm.com is being used. Alternately, the selected template, in this example template 545, may have a function identifier associated with it, which may or may not be visible to the user of the user computer email program.

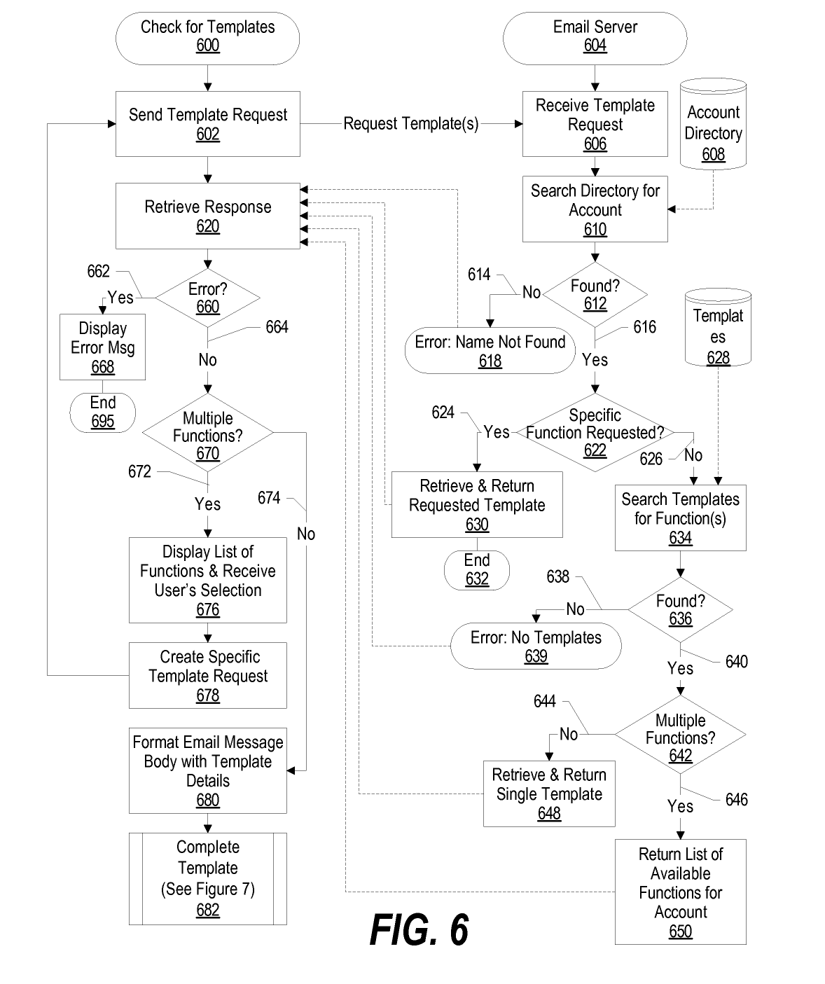

FIG. 6 is a flowchart showing the steps taken to request and retrieve a template in accordance with the present invention. Processing begins at 600 whereupon a user computer email program checks for templates by sending a template request to an email server (or service provider) (step 602). As discussed above, the template request may take the form of a web services request or an email to the account name, such as customer-service@us.ibm.com (as shown in the examples depicted in FIGS. 4 and 5). The template request may either be a request for all templates associated with the account name, or, in the case in which there are multiple templates associated with an account name, the template request may be a request for a specific template, identified by a function name or function identifier. Email server processing begins at 604 whereupon the template request is received by the email server (step 606). The email server searches account directory 608 for the requested account name (step 610). A determination is made as to whether the account name is found (decision 612). If the account name is not found, then decision 612 branches to “no” branch 614, whereupon a “name not found” error message is returned to the user computer email program and processing ends for the email server at 618. If the account name is not found, this means that the user typed in an invalid account name (i.e. email address). The user computer email program receives the error message at step 620, which is discussed in detail below.

Returning to decision 612, if the account name is found, then decision 612 branches to “yes” branch 616, whereupon a further determination is made as to whether the template request is for a specific function, identified by a function name or function identifier (decision 622). If a specific function associated with the account name is requested, then decision 622 branches to “yes” branch 624, whereupon the requested template is retrieved from template storage 628 and returned to the user computer email program (step 630). Processing then ends for the email server at 632. On the other hand, if a specific function is not requested (i.e. the template request is for an account name, but does not include a specific function name or function identifier), then decision 622 branches to “no” branch 626, whereupon the email server searches template storage 628 to find the template or templates associated with the function or functions that correspond to the account name (step 634). A determination is made as to whether any functions are found (decision 636). If no functions are found for the account name, this means that there are no templates associated with the account name and decision 636 branches to “no” branch 638, whereupon a “no templates” error message is returned to the user computer email program and processing ends for the email server at 639.

On the other hand, if functions are found for the requested account name, then decision 636 branches to “yes” branch 640, whereupon a determination is made as to whether there are multiple functions, i.e. templates, available for the requested account name (decision 642). If there is only a single function associated with the requested account name, then decision 642 branches to “no” branch 644, whereupon the single template is retrieved and returned to the user computer email program (step 648). If, however, there are multiple functions, i.e. templates, available for the requested account name, then decision 642 branches to “yes” branch 646, whereupon the list of available functions is returned to the user computer email program (step 650).

Returning to the user computer email program, a response is received from the email server (step 620). A determination is made as to whether the response is an error message, such as a “name not found” error or a “no templates” error (decision 660). If the response is an error message, then decision 660 branches to “yes” branch 662, whereupon the error message is displayed (step 668) and processing ends at 695. On the other hand, if the response is not an error message, then decision 660 branches to “no” branch 664, whereupon a further determination is made as to whether there are multiple functions, i.e. multiple templates, available for selection by the user (decision 670). If there are multiple functions available, decision 670 branches to “yes” branch 672, whereupon the user computer email program displays the list of available functions and receives a selection from the user (step 676). A specific template request is then created, including both the account name and the specific function requested (step 678). The specific template request is then sent to the email server (step 602).

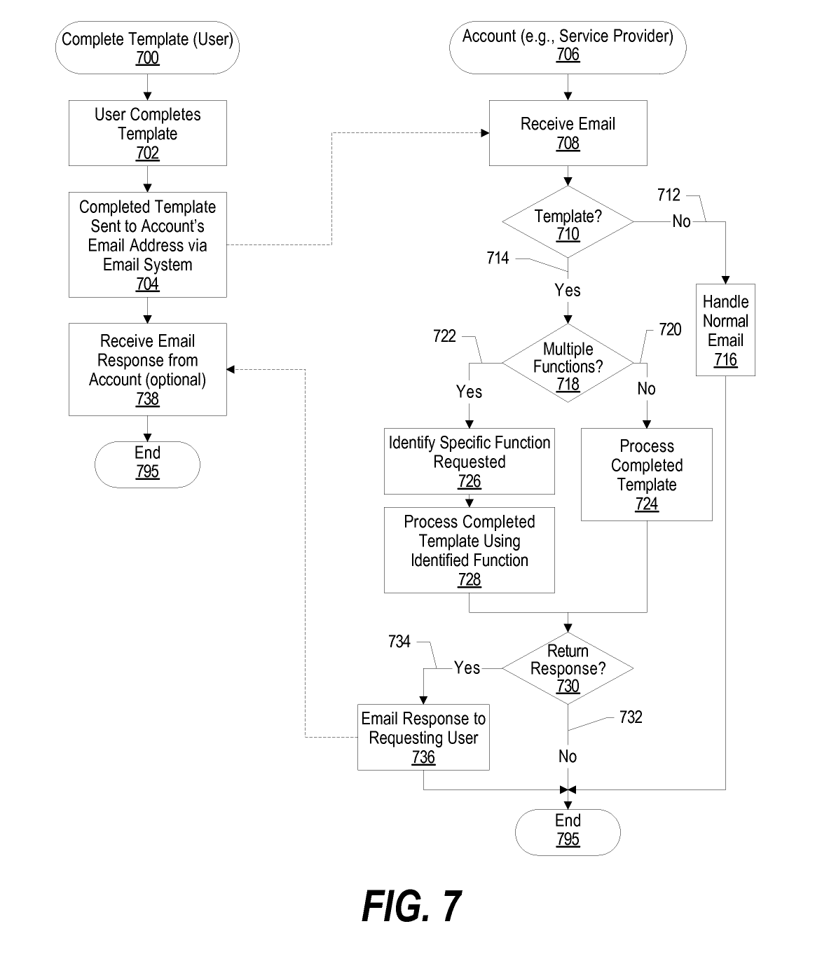

Returning to decision 670, if multiple functions are not available, then decision 670 branches to “no” branch 674, whereupon the user computer email program formats the current email message body with the template details of the returned template (step 680). The user then fills in the template fields and send the completed template to the email server or service provider (pre-defined process 682) as discussed in FIG. 7.

FIG. 7 is a flowchart showing the steps taken to complete a template and process the completed template in accordance with the present invention. Processing begins at 700 whereupon a user of a user computer email program completes a template by filling in the requested fields (step 702). The user then selects the send button and the user computer email program sends the completed template, incorporated into the body of an email message, to an account's email address via an email system (step 704). As discussed above with reference to FIG. 1, the account may be an email address that is set up to service the request specified by the completed template. Alternately, the account may be a service provider that receives the completed template directly from the user computer email program or from an email server.

Processing begins for the account, i.e. service provider, at 706, whereupon an message is received (step 708). A determination is made regarding whether the received email includes a template (decision 710). If the email does not include a template, then decision 710 branches to “no” branch 712, whereupon the email is handled as any other normal email (i.e. not containing a template) is handled (step 716). Processing then ends at 795.

If, however, the email does contain a template, decision 710 branches to “yes” branch 714, whereupon a further determination is made regarding whether the account name is set up to handle multiple functions (decision 718). If the account name is not set up to handle multiple functions, this means that only one template is associated with the account name (i.e. email address to which the template has been sent), and so decision 718 branches to “no” branch 720, whereupon the completed template is processed (step 724). As noted above, if only one template is associated with a corresponding email address, then the completed template may or may not include a function name or function identifier. Processing then continues at decision 730 as discussed below.

Returning to decision 718, if the account name is set up to handle multiple functions, each function having a corresponding template, then decision 718 branches to “yes” branch 722, whereupon the specific function is identified using a function name or function identifier (step 726). The completed template is processed according to the template associated with the account name and function identifier (step 728). Processing then continues at decision 730.

After the completed template is processed, a determination is made regarding whether a response should be returned to the user (decision 730). If no response needs to be returned, decision 730 branches to “no” branch 732, whereupon processing ends at 795. If, however, a response is to be returned to the user, decision 730 branches to “yes” branch 734, whereupon an email response is sent back to the requesting user (step 736). Processing ends for the account at 795. If a response is sent back to the requesting user, the user computer email program receives the response (step 738) and processing then ends for the user computer email program at 795.

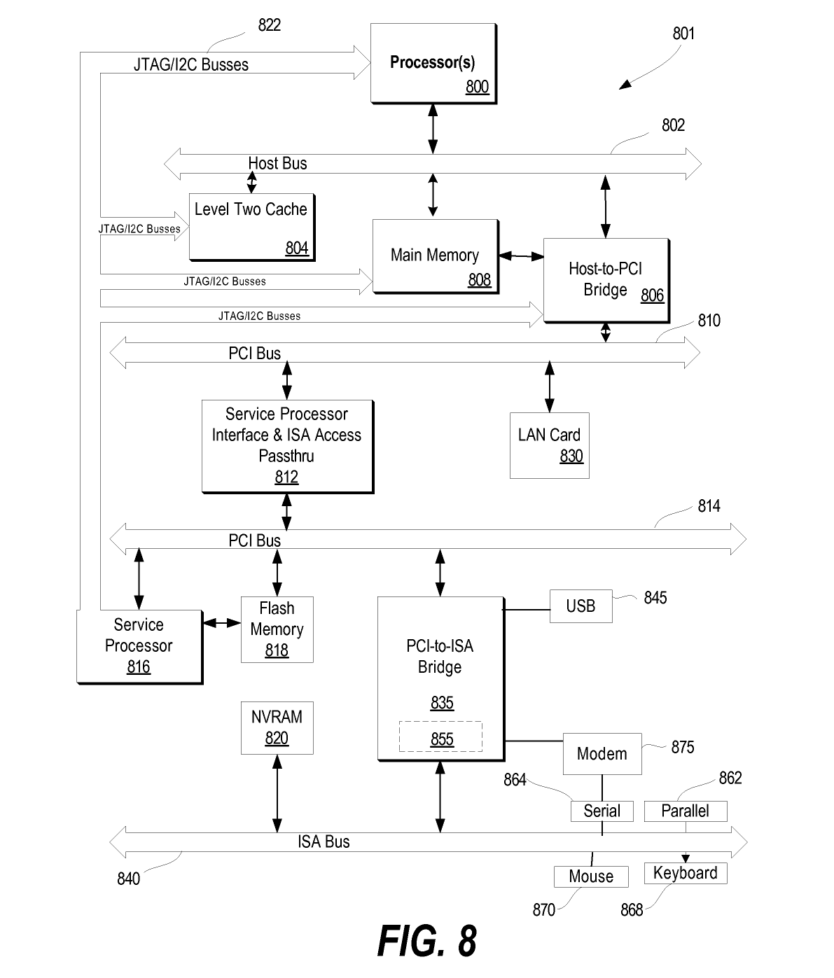

FIG. 8 illustrates information handling system 801 which is a simplified example of a computer system capable of performing the computing operations described herein. Computer system 801 includes processor 800 which is coupled to host bus 802. A level two (L2) cache memory 804 is also coupled to host bus 802. Host-to-PCI bridge 806 is coupled to main memory 808, includes cache memory and main memory control functions, and provides bus control to handle transfers among PCI bus 810, processor 800, L2 cache 804, main memory 808, and host bus 802. Main memory 808 is coupled to Host-to-PCI bridge 806 as well as host bus 802. Devices used solely by host processor(s) 800, such as LAN card 830, are coupled to PCI bus 810. Service Processor Interface and ISA Access Pass-through 812 provides an interface between PCI bus 810 and PCI bus 814. In this manner, PCI bus 814 is insulated from PCI bus 810. Devices, such as flash memory 818, are coupled to PCI bus 814. In one implementation, flash memory 818 includes BIOS code that incorporates the necessary processor executable code for a variety of low-level system functions and system boot functions.

PCI bus 814 provides an interface for a variety of devices that are shared by host processor(s) 800 and Service Processor 816 including, for example, flash memory 818. PCI-to-ISA bridge 835 provides bus control to handle transfers between PCI bus 814 and ISA bus 840, universal serial bus (USB) functionality 845, power management functionality 855, and can include other functional elements not shown, such as a real-time clock (RTC), DMA control, interrupt support, and system management bus support. Nonvolatile RAM 820 is attached to ISA Bus 840. Service Processor 816 includes JTAG and I2C busses 822 for communication with processor(s) 800 during initialization steps. JTAG/I2C busses 822 are also coupled to L2 cache 804, Host-to-PCI bridge 806, and main memory 808 providing a communications path between the processor, the Service Processor, the L2 cache, the Host-to-PCI bridge, and the main memory. Service Processor 816 also has access to system power resources for powering down information handling device 801.

Peripheral devices and input/output (I/O) devices can be attached to various interfaces (e.g., parallel interface 862, serial interface 864, keyboard interface 868, and mouse interface 870 coupled to ISA bus 840. Alternatively, many I/O devices can be accommodated by a super I/O controller (not shown) attached to ISA bus 840.

In order to attach computer system 801 to another computer system to copy files over a network, LAN card 830 is coupled to PCI bus 810. Similarly, to connect computer system 801 to an ISP to connect to the Internet using a telephone line connection, modem 875 is connected to serial port 864 and PCI-to-ISA Bridge 835.

While FIG. 8 shows one information handling system, an information handling system may take many forms. For example, an information handling system may take the form of a desktop, server, portable, laptop, notebook, or other form factor computer or data processing system. In addition, an information handling system may take other form factors such as a personal digital assistant (PDA), a gaming device, ATM machine, a portable telephone device, a communication device or other devices that include a processor and memory.

One of the preferred implementations of the invention is a client application, namely, a set of instructions (program code) or other functional descriptive material in a code module that may, for example, be resident in the random access memory of the computer. Until required by the computer, the set of instructions may be stored in another computer memory, for example, in a hard disk drive, or in a removable memory such as an optical disk (for eventual use in a CD ROM) or floppy disk (for eventual use in a floppy disk drive), or downloaded via the Internet or other computer network. Thus, the present invention may be implemented as a computer program product for use in a computer. In addition, although the various methods described are conveniently implemented in a general purpose computer selectively activated or reconfigured by software, one of ordinary skill in the art would also recognize that such methods may be carried out in hardware, in firmware, or in more specialized apparatus constructed to perform the required method steps. Functional descriptive material is information that imparts functionality to a machine. Functional descriptive material includes, but is not limited to, computer programs, instructions, rules, facts, definitions of computable functions, objects, and data structures.

While particular embodiments of the present invention have been shown and described, it will be obvious to those skilled in the art that, based upon the teachings herein, that changes and modifications may be made without departing from this invention and its broader aspects. Therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

What is claimed is:

1. A computer-implemented method comprising:
sending a template request, from a user computer email program to an email server, wherein the template request includes an email account name;
selecting, by the email server, a selected template from a plurality of stored templates, wherein the selected template corresponds to the email account name;
sending the selected template from the email server to the user computer email program; and
displaying, by the user computer email program, the selected template within an email message, wherein the selected template becomes part of a body of the email message.

2. The method of claim 1 wherein the selecting further comprises:
determining, by the email server, that more than one of the stored templates corresponds to the email account name;
sending a list of function names from the email server to the user computer email program, wherein each function name is associated with one of the stored templates that corresponds to the email account name;
receiving, by the user computer email program, the list of function names;
displaying the received list of function names to a user;
receiving, from the user, a selected function name from the list of function names;
in response to receiving the selected function name from the user, sending a specific template request from the user computer email program to the email server, wherein the specific template request includes the email account name and the selected function name; and
wherein the selected template corresponds to the email account name and the selected function name.

3. The method of claim 2 further comprising:
receiving, by the user computer email program, user input for one or more fields included in the selected template;
storing the user input and the selected function name in the selected template, resulting in a completed template;
sending the completed template to the email server;
receiving, by the email server, the completed template; and
in response to receiving the completed template, determining one or more actions to perform based upon the selected function name.

4. The method of claim 1 further comprising:
receiving, by the user computer email program, user input for one or more fields included in the selected template;
storing the user input in the selected template, resulting in a completed template; and
sending the completed template to the email server for further processing.

5. The method of claim 4 further comprising:
receiving, by the email server, the completed template;
sending the completed template from the email server to a service provider, wherein the service provider performs one or more actions in response to receiving the completed template.

6. The method of claim 1 wherein sending the template request further comprises:
reading the email account name, wherein the email account name is input by a user of the user computer email program; and
detecting that the user has requested a retrieve template function, wherein the user requests the retrieve template function by selecting a graphical control within the user computer email program.

7. The method of claim 1 further comprising:
reading the email account name, wherein the email account name is input by a user of the user computer email program;
detecting that the user has requested a retrieve template function, wherein the user requests the retrieve template function by selecting a graphical control within the user computer email program;
determining, by the email server, that more than one of the stored templates corresponds to the email account name;
sending a list of function names from the email server to the user computer email program, wherein each function name is associated with one of the stored templates that corresponds to the email account name;
receiving, by the user computer email program, the list of function names;
displaying the received list of function names to the user;
receiving, from the user, a selected function name from the list of function names;
in response to receiving the selected function name from the user, sending a specific template request from the user computer email program to the email server, wherein the specific template request includes the email account name and the selected function name, and wherein the selected template corresponds to the email account name and the selected function name;
receiving, by the user computer email program, user input for one or more fields included in the selected template;
storing the user input and the selected function name in the selected template, resulting in a completed template;
sending the completed template to the email server;
receiving, by the email server, the completed template; and
in response to receiving the completed template, determining one or more actions to perform based upon the selected function name.

8. A information handling system comprising:
one or more processors;
a memory accessible by at least one of the processors;
a nonvolatile storage area accessible by at least one of the processors;
a network interface adapter connecting the information handling system to a computer network; and
a set of instructions stored in the memory, wherein one or more of the processors executes the set of instructions in order to perform actions of:
sending a template request, from a user computer email program to an email server, wherein the template request includes an email account name;
selecting, by the email server, a selected template from a plurality of stored templates, wherein the selected template corresponds to the email account name;
sending the selected template from the email server to the user computer email program; and
displaying, by the user computer email program, the selected template within an email message, wherein the selected template becomes part of a body of the email message.

9. The information handling system of claim 8 wherein the set of instructions that perform the selecting perform further actions comprising:
determining, by the email server, that more than one of the stored templates corresponds to the email account name;
sending a list of function names from the email server to the user computer email program, wherein each function name is associated with one of the stored templates that corresponds to the email account name;
receiving, by the user computer email program, the list of function names;
displaying the received list of function names to a user;
receiving, from the user, a selected function name from the list of function names;
in response to receiving the selected function name from the user, sending a specific template request from the user computer email program to the email server, wherein the specific template request includes the email account name and the selected function name; and
wherein the selected template corresponds to the email account name and the selected function name.

10. The information handling system of claim 9 wherein the set of instructions perform further actions comprising:
receiving, by the user computer email program, user input for one or more fields included in the selected template;
storing the user input and the selected function name in the selected template, resulting in a completed template;
sending the completed template to the email server;
receiving, by the email server, the completed template; and
in response to receiving the completed template, determining one or more actions to perform based upon the selected function name.

11. The information handling system of claim 8 wherein the set of instructions perform further actions comprising:
receiving, by the user computer email program, user input for one or more fields included in the selected template;
storing the user input in the selected template, resulting in a completed template; and
sending the completed template to the email server for further processing.

12. The information handling system of claim 11 wherein the set of instructions perform further actions comprising:
receiving, by the email server, the completed template;
sending the completed template from the email server to a service provider, wherein the service provider performs one or more actions in response to receiving the completed template.

13. The information handling system of claim 8 wherein the set of instructions perform further actions comprising:
reading the email account name, wherein the email account name is input by a user of the user computer email program; and
detecting that the user has requested a retrieve template function, wherein the user requests the retrieve template function by selecting a graphical control within the user computer email program.

14. A computer program product stored in a computer readable medium, comprising functional descriptive material that, when executed by a data processing system, causes the data processing system to perform actions that include:
sending a template request, from a user computer email program to an email server, wherein the template request includes an email account name;
selecting, by the email server, a selected template from a plurality of stored templates, wherein the selected template corresponds to the email account name;
sending the selected template from the email server to the user computer email program; and
displaying, by the user computer email program, the selected template within an email message, wherein the selected template becomes part of a body of the email message.

15. The computer program product of claim 14 wherein the selecting further comprises wherein the functional descriptive material causes the data processing system to perform further actions comprising:
determining, by the email server, that more than one of the stored templates corresponds to the email account name;
sending a list of function names from the email server to the user computer email program, wherein each function name is associated with one of the stored templates that corresponds to the email account name;
receiving, by the user computer email program, the list of function names;
displaying the received list of function names to a user;
receiving, from the user, a selected function name from the list of function names;
in response to receiving the selected function name from the user, sending a specific template request from the user computer email program to the email server, wherein the specific template request includes the email account name and the selected function name; and
wherein the selected template corresponds to the email account name and the selected function name.

16. The computer program product of claim 15 wherein the functional descriptive material causes the data processing system to perform further actions comprising:
receiving, by the user computer email program, user input for one or more fields included in the selected template;
storing the user input and the selected function name in the selected template, resulting in a completed template;
sending the completed template to the email server;
receiving, by the email server, the completed template; and
in response to receiving the completed template, determining one or more actions to perform based upon the selected function name.

17. The computer program product of claim 14 wherein the functional descriptive material causes the data processing system to perform further actions comprising:
receiving, by the user computer email program, user input for one or more fields included in the selected template;
storing the user input in the selected template, resulting in a completed template; and
sending the completed template to the email server for further processing.

18. The computer program product of claim 17 wherein the functional descriptive material causes the data processing system to perform further actions comprising:
receiving, by the email server, the completed template;
sending the completed template from the email server to a service provider, wherein the service provider performs one or more actions in response to receiving the completed template.

19. The computer program product of claim 14 wherein the functional descriptive material causes the data processing system to perform further actions comprising:
reading the email account name, wherein the email account name is input by a user of the user computer email program; and
detecting that the user has requested a retrieve template function, wherein the user requests the retrieve template function by selecting a graphical control within the user computer email program.

20. The computer program product of claim 14 wherein the functional descriptive material causes the data processing system to perform further actions comprising:
reading the email account name, wherein the email account name is input by a user of the user computer email program;
detecting that the user has requested a retrieve template function, wherein the user requests the retrieve template function by selecting a graphical control within the user computer email program;
determining, by the email server, that more than one of the stored templates corresponds to the email account name;
sending a list of function names from the email server to the user computer email program, wherein each function name is associated with one of the stored templates that corresponds to the email account name;
receiving, by the user computer email program, the list of function names;
displaying the received list of function names to the user;
receiving, from the user, a selected function name from the list of function names;
in response to receiving the selected function name from the user, sending a specific template request from the user computer email program to the email server, wherein the specific template request includes the email account name and the selected function name, and wherein the selected template corresponds to the email account name and the selected function name;
receiving, by the user computer email program, user input for one or more fields included in the selected template;
storing the user input and the selected function name in the selected template, resulting in a completed template;
sending the completed template to the email server;
receiving, by the email server, the completed template; and
in response to receiving the completed template, determining one or more actions to perform based upon the selected function name.
